(19) United States
(12) Patent Application Publication
(10) Pub. No.: US 2015/0088669 A1
(43) Pub. Date: Mar. 26, 2015

(54) APPARATUS AND METHOD FOR PROVIDING RESPONSIVE USER INTERFACE AND ELECTRONIC DEVICE-READABLE RECORDING MEDIUM THEREFOR

(71) Applicant: SK PLANET CO., LTD, Seongnam-si, Gyeonggi-do (KR)

(72) Inventor: No Hyun Kwak, Seoul (KR)

(21) Appl. No.: 14/396,319

(22) PCT Filed: Jul. 31, 2013
(86) PCT No.: PCT/KR2013/006917

§ 371 Date: Oct. 22, 2014

(30) Foreign Application Priority Data
Aug. 16, 2012 (KR) 10-2012-0089492

(51) Int. Cl. G06F 17/22; G06F 17/30; G06Q 30/02

(52) U.S. Cl. CPC G06F 17/2247; G06Q 30/0241; G06F 17/30864; G06Q 30/0277
USPC 705/14.73; 715/234

(57) ABSTRACT

The present invention relates to an apparatus and method for providing a responsive user interface and an electronic device-readable recording medium therefor. The apparatus includes a screen setting value memory unit for storing layout setting values according to the size of a screen, a user interface unit for receiving a user command, a user command recognition unit for obtaining corresponding layout setting values from the screen setting value memory unit by analyzing a screen relocation command when the screen relocation command is inputted through the user interface unit, and a screen configuration control unit for reconfiguring the layout of the screen based on the obtained layout setting values, relocating the construction blocks of a corresponding web page in the reconfigured screen, and displaying the relocated web page on the reconfigured screen.

### CROSS REFERENCE TO RELATED APPLICATIONS

The present application claims priority to International Application PCT/KR2013/006917, with an International Filing Date of 31.07.2013, which claims the benefit of Korean Patent Application No. 10-2012-0089492 filed in the Korean Intellectual Property Office on 16.08.2012, the entire contents of which are incorporated herein by reference.

### BACKGROUND OF THE INVENTION

1. Technical Field

The present invention relates to an apparatus and method for providing a responsive user interface and an electronic device-readable recording medium therefor and, more particularly, to an apparatus and method for providing a responsive user interface, wherein when a screen relocation command is inputted in the state in which a web page has been displayed, corresponding layout setting values are obtained by analyzing the screen relocation command, the layout of a screen is reconfigured based on the layout setting values, the construction blocks of the web page are relocated, and the relocated web page is displayed on the reconfigured screen, and an electronic device-readable recording medium therefor.

2. Description of the Related Art

As wireless communication terminals, such as portable phones or Portable Digital Assistants (PDA), are widely used and a wireless Internet becomes active, an Internet web page has become accessible at a specific place through a wireless communication terminal.

In general, a wireless communication terminal has a small display window size because mobility or portability needs to be taken into consideration, and thus the size of a screen that can be reproduced through such a display window having a small display window size is limited.

Accordingly, if a common web page not a mobile-dedicated web page is accessed through a wireless communication terminal, only some region of the entire web page is displayed on a screen. Thus, a user must scroll the screen right and left and upward and downward in order to view the entire web page.

To view a web page while scrolling a screen right and left and upward and downward is inconvenient in use, and there is a problem in that an unnecessary image or link, such as an advertisement, is erroneously selected in the process of scrolling the screen of the web page.

Accordingly, a text only mode in which all pieces of image information are excluded from a web page and only text is displayed on a screen, a method of reducing the size of the entire web page to the size of a screen of a wireless communication terminal and displaying the reduced web page on the screen, etc. may be used.

However, to obviate all images from a web page is not appropriate because a desired image to be seen by a user also disappears. If the size of a web page is reduced to the size of a screen of a wireless communication terminal, there is a problem in that the contents of the web page may not be easily recognized because the size of letters or images included in the web page is also reduced.

Accordingly, it is necessary to reconfigure and display a web page in order to provide user convenience other than a method of controlling the size of the entire web page or of obviating all images and displaying a reduced web page.

### SUMMARY OF THE INVENTION

The present invention has been made to solve the above problems, and an object of the present invention is to provide an apparatus and method for providing a responsive user interface, wherein a part of a responsive UI whose screen is relocated can be easily recognized in such a manner that the responsive UI is controlled in accordance with a user's interaction in addition to resolution (screen size), and an electronic device-readable recording medium therefor.

Another object of the present invention is to provide an apparatus and method for providing a responsive user interface, wherein layouts configured in accordance with various devices or various screens can be checked through only a user's interface, and an electronic device-readable recording medium therefor.

Yet another object of the present invention is to provide an apparatus and method for providing a responsive user interface, wherein when the relocation of a screen is requested, a preview function is provided so that a web page to be relocated is displayed with transparency different from that of a currently displayed web page and thus the configuration of a screen to be relocated can be easily recognized, and an electronic device-readable recording medium therefor.

Further yet another object of the present invention is to provide an apparatus and method for providing a responsive user interface, wherein a screen configuration automatically switches to another screen configuration through an interval control function, and an electronic device-readable recording medium therefor.

Further yet another object of the present invention is to provide an apparatus and method for providing a responsive user interface, wherein an advertisement can be provided during the time when a screen is relocated because a responsive UI is controlled in accordance with a user's interaction in addition to resolution (screen size), and an electronic device-readable recording medium therefor.

Further yet another object of the present invention is to provide an apparatus and method for providing a responsive user interface, wherein when data is loaded while a screen is relocated, an advertisement exposure time is increased in such a manner that the advertisement gradually disappears or a sound effect is provided in order to attract a user's attention, and an electronic device-readable recording medium therefor.

In accordance with an aspect of the present invention, there is provided an apparatus for providing a responsive user interface, including a screen setting value memory unit for storing layout setting values according to the size of a screen, a user interface unit for receiving a user command, a user command recognition unit for obtaining corresponding layout setting values from the screen setting value memory unit by analyzing a screen relocation command when the screen relocation command is inputted through the user interface unit, and a screen configuration control unit for reconfiguring the layout of the screen based on the obtained layout setting values, relocating the construction blocks of a corresponding web page in the reconfigured screen, and displaying the relocated web page on the reconfigured screen.

The apparatus for providing a responsive user interface may further include an advertisement memory unit for storing advertisements. The screen configuration control unit may expose an advertisement in a construction block of the web page in accordance with a predetermined advertisement scheduling algorithm from the time when the layout of the screen starts to be reconfigured until the relocated web page is displayed.

The screen configuration control unit may output a sound effect while the advertisement is exposed.

Furthermore, the screen configuration control unit may gradually remove the advertisement when corresponding data is loaded onto the construction block on which the advertisement has been displayed.

Furthermore, the screen configuration control unit may display the web page to be relocated with transparency different from the transparency of a currently displayed web page when the screen relocation command is inputted.

The screen relocation command may be inputted by selecting at least one screen location mode of normal mode, narrow mode, and mobile mode using a predetermined button or may be inputted through a web page interval control function.

When a screen relocation command for one of the normal mode, the narrow mode, and the mobile mode is inputted using the predetermined button, the user command recognition unit may check a media query of the web page, corresponding to the screen relocation command, in the screen setting value memory unit and obtain layout setting values of the construction blocks of the web page by analyzing the media query.

Furthermore, when the screen relocation command is inputted through the web page interval control function, the user command recognition unit may check a screen location mode having the size of a screen nearest to a controlled screen size and obtain layout setting values corresponding to the checked screen location mode.

Layout setting values of construction blocks of a web page for each of normal mode, narrow mode, and mobile mode are designated as a media query in the screen setting value memory unit.

In accordance with another aspect of the present invention, there is provided a method of providing, by the apparatus for providing a responsive user interface, a responsive user interface, including steps of (a) obtaining corresponding layout setting values by analyzing a screen relocation command when the screen relocation command is inputted in a state in which a web page has been displayed and (b) reconfiguring the layout of a screen based on the obtained layout setting values, relocating the construction blocks of the web page in the reconfigured screen, and displaying the relocated web page on the reconfigured screen.

The step (a) may include steps of determining a screen location mode corresponding to the screen relocation command when the screen relocation command for one of normal mode, narrow mode, and mobile mode is inputted and obtaining layout setting values of the construction blocks of the web page by analyzing a media query corresponding to the determined screen location mode.

Furthermore, the step (a) may include steps of checking a screen location mode having the size of a screen nearest to a controlled screen size when the screen relocation command is inputted through a web page interval control function and obtaining layout setting values of construction blocks of the web page by analyzing a media query corresponding to the checked screen location mode.

In the step (b), an advertisement may be exposed in a construction block of the web page in accordance with a predetermined advertisement scheduling algorithm from the time when the layout of the screen starts to be reconfigured until the relocated web page is displayed.

In accordance with yet another aspect of the present invention, there is provided an electronic device-readable recording medium on which a method for providing a responsive user interface is recorded as a program, the method including steps of, when a screen relocation command is inputted in the state in which a web page has been displayed, obtaining corresponding layout setting values by analyzing the screen relocation command, reconfiguring the layout of a screen based on the obtained layout setting values, relocating the construction blocks of the web page in the reconfigured screen, and displaying the relocated web page on the reconfigured screen.

### BRIEF DESCRIPTION OF THE DRAWINGS

FIG. 1 is a block diagram showing the construction of an apparatus for providing a responsive user interface in accordance with the present invention.

FIG. 2 is an exemplary diagram showing a media query in accordance with the present invention.

FIG. 3 is a flowchart illustrating a method of providing, by the apparatus for providing a responsive user interface, a responsive user interface in accordance with an embodiment of the present invention.

FIG. 4 shows exemplary screens illustrating a responsive user interface in accordance with the present invention.

FIG. 5 is a flowchart illustrating a method of providing, by a user terminal, a responsive user interface in accordance with another embodiment of the present invention.

FIG. 6 shows an exemplary screen illustrating a method of relocating a web page using an interval control function in accordance with the present invention.

FIG. 7 is a flowchart illustrating a method of providing, by a user terminal, a responsive user interface in accordance with yet another embodiment of the present invention.

FIGS. 8 and 9 are exemplary diagrams of screens on which advertisements are exposed when the screens are reconfigured in accordance with the present invention.

### DESCRIPTION OF REFERENCE NUMERALS OF PRINCIPAL ELEMENTS IN THE DRAWINGS

100: apparatus for providing a responsive user interface
110: communication unit 120: user interface unit
130: user command recognition unit
140: screen setting value memory unit
150: screen configuration control unit
160: advertisement memory unit
170: audio processing unit

### DETAILED DESCRIPTION

The details of the aforementioned objects, technical construction, and operational effects of the present invention will be more clearly understood from the following detailed description based on the accompanying drawings attached to the specification of the present invention.

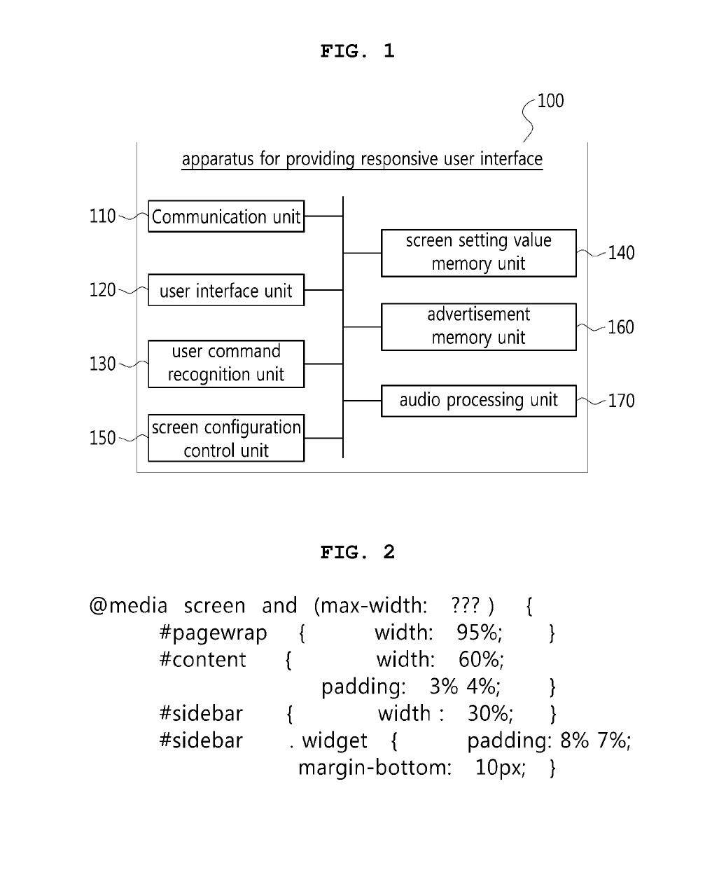

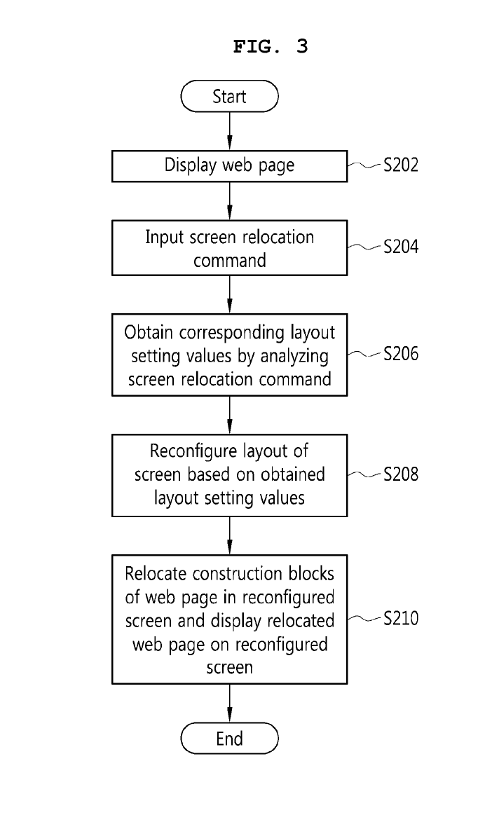

FIG. 1 is a block diagram showing the construction of an apparatus for providing a responsive user interface in accordance with the present invention, and FIG. 2 is an exemplary diagram showing a media query in accordance with the present invention.

Referring to FIG. 1, the apparatus for providing a responsive user interface 100 includes a communication unit 110 for being supplied with a web page over a communication network, a user interface unit 120, a user command recognition unit 130, a screen setting value memory unit 140, and a screen configuration control unit 150.

The communication unit 110 is communication means for connecting the apparatus for providing a responsive user interface 100 and a web service providing apparatus for providing a web page over a communication network. The communication unit 110 may include, for example, a wireless communication module, such as mobile communication or satellite communication, a wired communication module, such as the Internet, and a short-range wireless communication module, such as Wi-Fi.

The screen setting value memory unit 140 stores layout setting values according to screen sizes. That is, the screen setting value memory unit 140 stores layout setting values for screens in accordance with screen sizes for the horizontal widths or vertical heights of the screens on which web pages will be displayed.

A web page is made up of blocks, such as a header block, a content block, a sidebar block, and a footer block. A layout setting value on which each of the construction blocks will be displayed is previously set in each web page based on the size of a screen on which the web page will be displayed. Accordingly, when a web page is received, the apparatus for providing a responsive user interface 100 also receives layout setting values of the construction blocks of the web page according to the size of a screen along with the web page and stores the layout setting values in the screen setting value memory unit 140. Here, in the screen setting value memory unit 140, layout setting values of the construction blocks of a web page according to the size of a screen have been designated in the form of a media query.

Furthermore, the screen setting value memory unit 140 stores layout setting values of the construction blocks of a web page for each of normal mode, narrow mode, and mobile mode. Here, the layout setting value has been designated in the form of a media query.

Display devices, such as smart phones, tablets, and computers, are various, and displayed resolution is also various. A media query has been made to correspond to such environments. To put it simply, a media query refers to a function of controlling a thing that is seen in accordance with device resolution. The layout of a screen can be flexibly produced through the media query.

A media query has attributes, such as width (the width of a screen), height (the height of a screen), device width (the width of a terminal), device-height (the height of a terminal), orientation (horizontal/vertical mode of a screen), an aspect ratio (screen ratio), a device aspect ratio (a screen ratio of a terminal), color (the number of color bits), a color index (the number of color table entries), monochrome (the number of bits per pixel of a monochrome frame buffer), resolution (screen resolution), scan (a scan method of TV), and grid (whether it is a grid or bitmap method).

For example, the apparatus for providing a responsive user interface 100 designates a relative value (%) in accordance with a screen location mode so that the layout of a screen is flexibly changed based on a width value of a browser as in FIG. 2. In such a case, the apparatus for providing a responsive user interface 100 can be aware of layout setting values based on @media and a max-width value. Here, the screen location mode refers to normal mode, narrow mode, or mobile mode.

The user interface unit 120 operates as an input unit for receiving a user command or a display unit for displaying results according to a user command.

If the user interface unit 120 operates as the input unit, the user interface unit 120 converts a user request into an electrical signal in response to a user's manipulation as means for receiving the user request for controlling the operation of the apparatus for providing a responsive user interface 100. The input unit may include key input means for receiving the alphabet, numbers, and text information from a user, voice recognition means for receiving a user's voice or an audio signal through a microphone, image acquisition means, such as a camera for obtaining an image by photographing an object, an RFID reader, a code reader, and so on. The key input means may be implemented using a keyboard, a keypad, a touch screen or the like.

If the user interface unit 120 operates as the display unit, the user interface unit 120 can display and process screen information according to the driving of an application through display means, for example, a Liquid Crystal Display (LCD) or Organic Light Emitting Diodes (OLED).

When a screen relocation command is inputted through the user interface unit 120, the user command recognition unit 130 obtains corresponding layout setting values from the screen setting value memory unit 140 by analyzing the screen relocation command.

That is, a user can input a screen relocation command for requesting the relocation of a currently displayed screen using a method of selecting a predetermined button or a screen touch method in a screen on which a web page has been displayed. Here, the screen relocation command may include normal mode, narrow mode, mobile mode, etc. In such a case, the user command recognition unit 130 checks a media query corresponding to the screen relocation command in relation to the currently displayed web page by searching the screen setting value memory unit 140 and obtains layout setting values of the construction blocks of the web page by analyzing the media query.

For example, when a user inputs a screen relocation command in narrow mode in the state in which a currently displayed web page is normal mode, the user command recognition unit 130 checks a media query for the narrow mode of the currently displayed web page by searching the screen setting value memory unit 140 and obtains layout setting values of construction blocks for displaying the currently displayed web page in narrow mode by analyzing the checked media query.

Furthermore, a user may input a screen relocation command for requesting the relocation of a screen using an interval control function in a screen on which a web page has been displayed. In such a case, the user command recognition unit 130 checks a screen location mode having the size of a screen that is nearest to the size of a screen controlled by the user in relation to a currently displayed web page and obtains layout setting values for the screen location mode from the screen setting value memory unit 140. That is, the user command recognition unit 130 checks a media query corresponding to the checked screen location mode by searching the screen setting value memory unit 140 and obtains layout setting values of the construction blocks of the web page for relocating the screen by analyzing the media query.

The screen configuration control unit 150 reconfigures the layout of a screen based on layout setting values obtained by the user command recognition unit 130, relocates the construction blocks of a corresponding web page in the reconfigured screen, and displays the relocated web page on the reconfigured screen. That is, the screen configuration control unit 150 reconfigures the layout of a screen on which the construction blocks of a corresponding web page will be displayed based on the layout setting values, relocates the construction blocks of the web page in the reconfigured screen, and displays the relocated web page on the reconfigured screen. Here, the screen configuration control unit 150 does not change an actual screen size, but changes only a layout size on which the web page will be displayed.

Furthermore, when a user inputs a screen relocation command, the screen configuration control unit 150 can provide a function of displaying a screen to be relocated in response to the screen relocation command with transparency different from that of a currently displayed web page so that a web page to be relocated can be previously checked. In other words, when a screen relocation command is inputted, the screen configuration control unit 150 displays a web page to be relocated with transparency different from that of a currently displayed web page so that a user can check a web page to be relocated in advance through the different transparency.

For example, when narrow mode switches to mobile mode, the screen configuration control unit 150 may configure a screen in mobile mode to be more transparent than a screen in narrow mode and display the screen in mobile mode.

In accordance with another aspect of the present invention, the apparatus for providing a responsive user interface 100 may further include an advertisement memory unit 160 for storing advertisements. In such a case, the screen configuration control unit 150 can expose an advertisement in a construction block of a web page from the time when the reconfiguration of the layout of a screen starts until a relocated web page is displayed in accordance with a predetermined advertisement scheduling algorithm. The apparatus for providing a responsive user interface 100 has been illustrated as storing advertisements, but the apparatus for providing a responsive user interface 100 may receive an advertisement through the communication unit 110 and provide the received advertisement.

Although a screen is relocated, the construction blocks of a screen maintain their structures using a tag <div>. In this case, all the blocks may be replaced with an advertisement image while the blocks are moving by applying a transition effect to all the blocks and increasing a transition time, and when the advertisement image is clicked on, a screen may move to a corresponding advertisement. That is, when a screen relocation command is inputted, the screen configuration control unit 150 applies Cascading Style Sheet (CSS) to which an advertisement has been applied and displays a relocated web page by applying the original CSS when a specific time elapses in a timer.

Furthermore, the screen configuration control unit 150 may display an advertisement on the construction blocks of a web page when reconfiguring the layout of a screen and may make the advertisement gradually disappear when corresponding data is loaded onto a construction block on which the advertisement has been displayed. For example, when data is loaded onto a content block, the screen configuration control unit 150 may replace an empty part with an advertisement image and gradually remove the advertisement image as the data is loaded.

Furthermore, the screen configuration control unit 150 may output a sound effect through the audio processing unit 170 while an advertisement is exposed. In general, background music is unwelcome to a user, but the time taken for a screen configuration to be changed is not long and may not be unwelcome to a user from a feedback viewpoint for a user's action. Accordingly, the screen configuration control unit 150 may provide a proper advertisement sound effect while reconfiguring a screen.

The apparatus for providing a responsive user interface 100 may be a user terminal. For example, the user terminal may include various types of devices, such as a notebook, a mobile communication terminal, a smart phone, a Portable Media Player (PMP), a Portable Digital Assistant (PDA), a tablet PC, a set-top box, and smart TV.

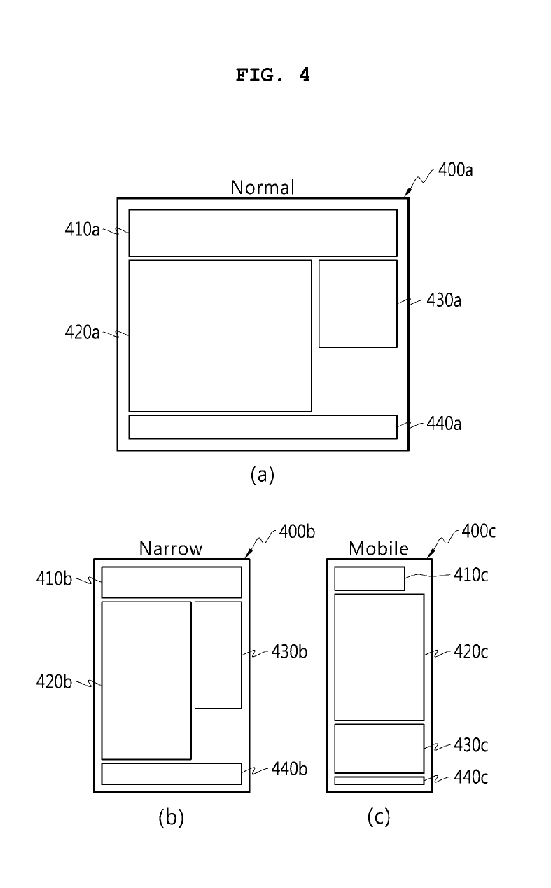

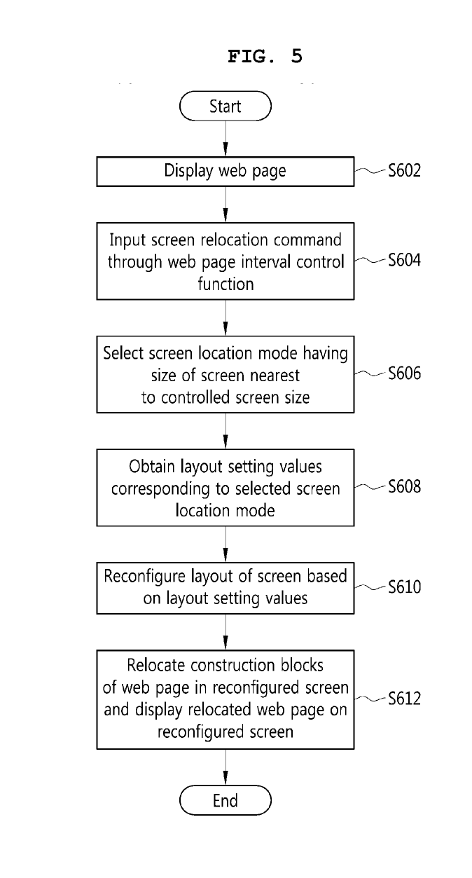

FIG. 3 is a flowchart illustrating a method of providing, by the apparatus for providing a responsive user interface, a responsive user interface in accordance with an embodiment of the present invention, and FIG. 4 shows exemplary screens illustrating a responsive user interface in accordance with the present invention. The apparatus for providing a responsive user interface is hereinafter called a user terminal.

Referring to FIG. 3, when a screen relocation command is inputted (S204) in the state in which a web page has been displayed on a screen (S202), the user terminal obtains corresponding layout setting values by analyzing the screen relocation command (S206). That is, when a screen relocation command for one screen location mode of normal mode, narrow mode, and mobile mode is inputted, the user terminal determines a screen location mode corresponding to the screen relocation command. Thereafter, the user terminal obtains layout setting values of the construction blocks of the web page by analyzing a media query corresponding to the determined screen location mode.

Thereafter, the user terminal reconfigures the layout of the screen based on the obtained layout setting values (S208), relocates the construction blocks of the web page in the reconfigured screen, and displays the relocated web page on the reconfigured screen (S210).

For example, a case where a current web page is in normal mode as in FIG. 4(a) is described below. Referring to (a), a web page 400a in normal mode includes a header block 410a, a content block 420a, two sidebar blocks 430a, and a footer block 440a. Here, the two sidebar blocks 430a are displayed on some region on the right side of the content block 420a.

When a user inputs a screen relocation command corresponding to narrow mode, the user terminal reconfigure the layout of a screen based on layout setting values set for narrow mode, relocates a web page in the screen reconfigured as in (b), and displays the relocated web page on the reconfigured screen. An actual screen size is not changed, and the relocated web page is displayed as in (b). From (b), it can be seen that a web page 400b in narrow mode has the same structure as the web page 400a in normal mode, but the web page in narrow mode has a smaller size than the web page 400a in normal mode.

Furthermore, when a user inputs a screen relocation command corresponding to mobile mode, the user terminal reconfigures the layout of a screen based on layout setting values set for mobile mode, relocates a web page in the screen reconfigured as in (c), and displays the relocated web page on the reconfigured screen. Here, an actual screen size is not changed, and the relocated web page is displayed. Referring to (c), a header block 410c, a content block 420c, two sidebar blocks 430c, and a footer block 440c are sequentially vertically lined up in a web page 400c in mobile mode.

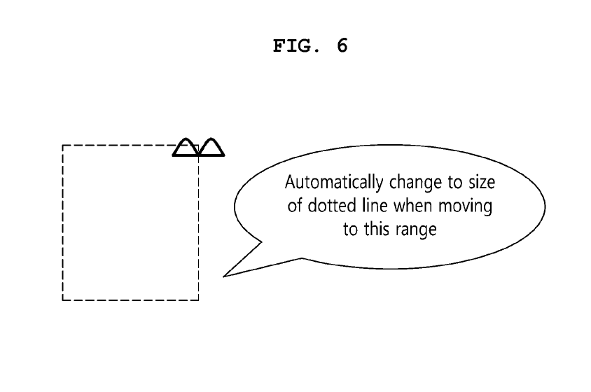

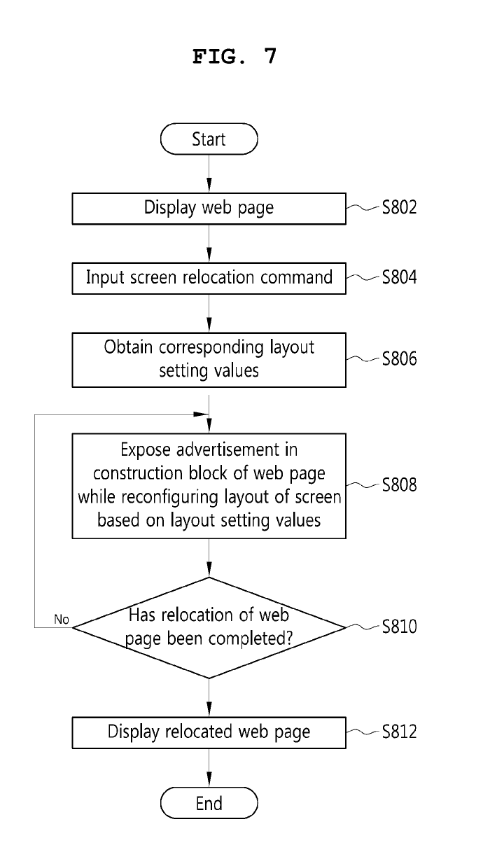

FIG. 5 is a flowchart illustrating a method of providing, by the user terminal, a responsive user interface in accordance with another embodiment of the present invention, and FIG. 6 shows an exemplary screen illustrating a method of relocating a web page using an interval control function in accordance with the present invention.

Referring to FIG. 5, when a screen relocation command is inputted through the web page interval control function (S604) in the state in which a web page has been displayed on a screen (S602), the user terminal selects a screen location mode having the size of a screen that is nearest to a controlled screen size (S606).

Thereafter, the user terminal checks layout setting values corresponding to the selected screen location mode (S608), reconfigures the layout of the screen based on the layout setting values (S610), relocates the construction blocks of the web page in the reconfigured screen, and displays the relocated web page on the reconfigured screen (S612).

For example, when a web page is selected and the size of a screen is controlled using the interval control function as in FIG. 6 in the screen on which the web page has been displayed as in FIG. 4(a), the user terminal recognizes such control to be a screen relocation command that requests the screen to be relocated to a controlled screen size. Thereafter, the user terminal checks a screen location mode having the size of a screen that is nearest to the size of the screen controlled by a user, reconfigures the layout of the screen based on layout setting values for the checked screen location mode, relocates the web page in the reconfigured screen, and displays the relocated web page on the reconfigured screen.

For example, if the size of the screen controlled by the user is nearest to the size of a screen corresponding to mobile mode, the user terminal relocates and displays a screen, such as that of FIG. 4(a), as in FIG. 4(c).

As described above, when a user controls the size of a screen, the user terminal checks layout setting values on which a screen is changed between screen location modes. When the size of a screen nearest to the size of a screen corresponding to a screen location mode is controlled, the user terminal checks a screen location mode having the size of a screen that is nearest to the size of the screen controlled by a user and reconfigures the screen by automatically changing the layout setting values for the checked screen location mode.

A process of checking a screen location mode having the size of a screen that is nearest to the size of a screen controlled by a user when a user tries to relocate a web page using the interval control function is described in more detail with reference to FIG. 6.

As shown in FIG. 6, each of the screen location modes (i.e., normal mode, narrow mode, and mobile mode) has the size of a screen corresponding to each mode. Furthermore, the screen location mode has a specific range based on the size of a screen. To check a screen location mode having the size of a screen that is nearest to a controlled screen size when a user controls the size of a screen using the interval control function means that whether or not a screen size corresponding to each screen location mode is within a specific range and a screen location mode having a corresponding specific range is checked and selected if, as a result of the determination, the screen size is within the specific range. If a screen location mode having a specific range is checked, the size of a screen controlled by a user is automatically changed into the size of a screen corresponding to the checked screen location mode. Thereafter, a screen is reconfigured based on layout setting values for the checked screen location mode, a web page is relocated in the reconfigured screen, and the relocated web page is displayed on the reconfigured screen.

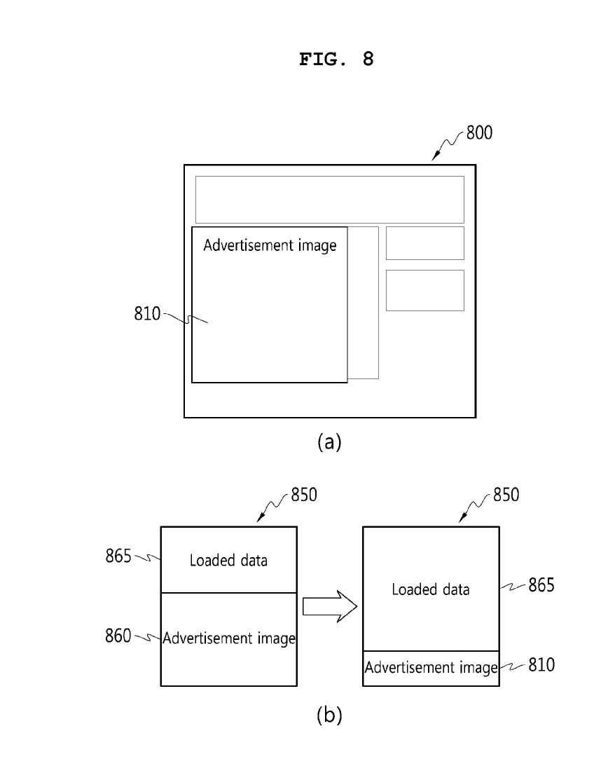

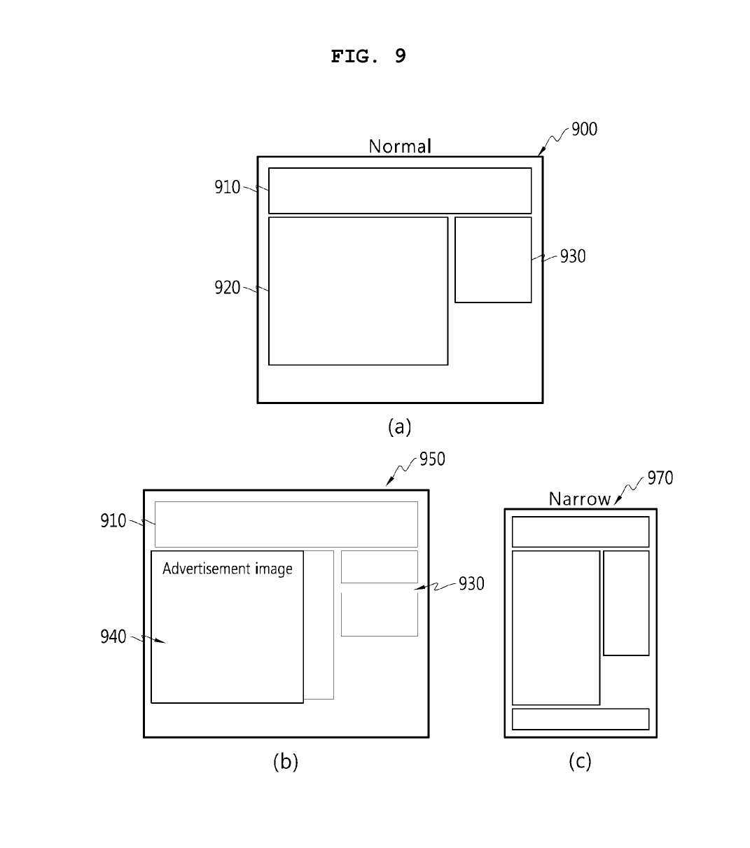

FIG. 7 is a flowchart illustrating a method of providing, by the user terminal, a responsive user interface in accordance with yet another embodiment of the present invention, and FIGS. 8 and 9 are exemplary diagrams of screens on which advertisements are exposed when the screens are reconfigured in accordance with the present invention.

Referring to FIG. 7, when a screen relocation command is inputted (S804) in the state in which a web page has been displayed on a screen (S802), the user terminal obtains layout setting values corresponding to the screen relocation command (S806). Here, a user may select at least one screen relocation command of normal mode, narrow mode, and mobile mode using a predetermined button or input the screen relocation command through the web page interval control function. In response thereto, the user terminal can obtain layout setting values corresponding to the screen relocation command.

When step S806 is performed, the user terminal exposes an advertisement in a construction block of the web page while reconfiguring the layout of the screen based on the layout setting values (S808). Here, the user terminal exposes the advertisement in the construction block of the web page in accordance with a predetermined advertisement scheduling algorithm. Furthermore, the web page includes blocks, such as header, content, sidebar, and footer, and thus the user terminal can expose the advertisement in at least one of the header block, the content block, the sidebar block, and the footer block.

For example, the user terminal may change a content block 810 into an advertisement image as in FIG. 8(a) and exposes the advertisement by increasing a transition time taken for the content block to move.

Furthermore, the user terminal may make an advertisement 860 gradually disappear when data is loaded (865) onto a content block 850 as in FIG. 8(b). That is, when data is loaded onto a content block, the user terminal may replace an empty part with an advertisement image and gradually remove the advertisement image as data is loaded.

If the relocation of the web page is completed (S810) while performing step S808, the user terminal displays the relocated web page (S812).

For example, a case where a current web page is normal mode as in FIG. 9(a) is described below.

Referring to (a), a web page 900 in normal mode includes a header block 910, a content block 920, two sidebar blocks 930, and a footer block (not shown).

When a user inputs a screen relocation command corresponding to narrow mode in the web page 900 in normal mode, the user terminal can expose an advertisement image in a content block 940 as in (b) until a web page reconfigured as in (c) is displayed.

Furthermore, in accordance with another aspect of the present invention, there is provided an electronic device-readable recording medium on which a method for providing a responsive user interface, including steps of, when a screen relocation command is inputted in the state in which a web page has been displayed, obtaining corresponding layout setting values by analyzing the screen relocation command, reconfiguring the layout of a screen based on the obtained layout setting values, relocating the construction blocks of the web page in the reconfigured screen, and displaying the relocated web page on the reconfigured screen, has been recorded as a program.

The method for providing a responsive user interface can be written as a program, and pieces of code and code segments that make up the program can be easily induced by a programmer skilled in the art. Furthermore, the program regarding the method for providing a responsive user interface can be stored in a medium readable by an electronic device and read and executed by an electronic device.

In accordance with the present invention, a part whose screen will be relocated can be easily recognized because a responsive UI can be controlled in accordance with a user's interaction as well as resolution (screen size).

Furthermore, a layout configured according to various devices or various screens can be checked through only a user's interface.

Furthermore, when the relocation of a screen is requested, the preview function is provided so that a web page to be relocated is displayed with transparency different from that of a currently displayed web page. Accordingly, the configuration of a screen to be relocated can be easily recognized.

Furthermore, a screen configuration can automatically switch to another screen configuration through the interval control function.

Furthermore, an advertisement can be provided during the time when a screen is relocated because a responsive UI is controlled in accordance with a user's interaction in addition to resolution (screen size).

Furthermore, an advertisement gradually disappears while loading data when a screen is relocated. Accordingly, a user's attention can be further attracted by increasing an advertisement exposure time or providing a sound effect.

The present invention can be applied to an apparatus and method for providing a responsive user interface, wherein a part whose screen will be relocated can be easily recognized because a responsive UI can be controlled in accordance with a user's interaction as well as resolution (screen size), and an electronic device-readable recording medium therefor.

Furthermore, the present invention can be applied to an apparatus and method for providing a responsive user interface, wherein an advertisement can be provided during a short time when a screen is relocated because a responsive UI is controlled in accordance with a user's interaction as well as resolution (screen size), and an electronic device-readable recording medium therefor.

As described above, those skilled in the art to which the present invention pertains will understand that the present invention may be implemented in other various forms without departing from the technical spirit or essential characteristics of the present invention. Accordingly, the aforementioned embodiments should not be construed as being limitative, but should be construed as being only illustrative from all aspects. The scope of the present invention is clearly disclosed in the appended claims rather than the detailed description. It should be understood that all modifications or variations derived from the meanings and scope of the present invention and equivalents thereof are included in the scope of the appended claims.

What is claimed is:

1. An apparatus for providing a responsive user interface, comprising:
a screen setting value memory unit for storing layout setting values according to a size of a screen;
a user interface unit for receiving a user command;
a user command recognition unit for obtaining corresponding layout setting values from the screen setting value memory unit by analyzing a screen relocation command when the screen relocation command is inputted through the user interface unit; and
a screen configuration control unit for reconfiguring the layout of the screen based on the obtained layout setting values, relocating construction blocks of a corresponding web page in the reconfigured screen, and displaying the relocated web page on the reconfigured screen.

2. The apparatus of claim 1, further comprising an advertisement memory unit for storing advertisements, wherein the screen configuration control unit exposes an advertisement in a construction block of the web page in accordance with a predetermined advertisement scheduling algorithm from a time when the layout of the screen starts to be reconfigured until the relocated web page is displayed.

3. The apparatus of claim 2, wherein the screen configuration control unit outputs a sound effect while the advertisement is exposed.

4. The apparatus of claim 2, wherein the screen configuration control unit gradually removes the advertisement when corresponding data is loaded onto the construction block on which the advertisement has been displayed.

5. The apparatus of claim 1, wherein the screen configuration control unit displays the web page to be relocated with transparency different from transparency of a currently displayed web page when the screen relocation command is inputted.

6. The apparatus of claim 1, wherein the screen relocation command is inputted by selecting at least one screen location mode of normal mode, narrow mode, and mobile mode using a predetermined button or inputted through a web page interval control function.

7. The apparatus of claim 6, wherein when a screen relocation command for one of the normal mode, the narrow mode, and the mobile mode is inputted using the predetermined button, the user command recognition unit checks a media query of the web page, corresponding to the screen relocation command, in the screen setting value memory unit and obtains layout setting values of construction blocks of the web page by analyzing the media query.

8. The apparatus of claim 6, wherein when the screen relocation command is inputted through the web page interval control function, the user command recognition unit checks a screen location mode having a size of a screen nearest to a controlled screen size and obtains layout setting values corresponding to the checked screen location mode.

9. The apparatus of claim 1, wherein layout setting values of construction blocks of a web page for each of normal mode, narrow mode, and mobile mode are designated as a media query in the screen setting value memory unit.

10. A method of providing, by an apparatus for providing a responsive user interface, a responsive user interface, the method comprising steps of:
(a) obtaining corresponding layout setting values by analyzing a screen relocation command when the screen relocation command is inputted in a state in which a web page has been displayed; and
(b) reconfiguring a layout of a screen based on the obtained layout setting values, relocating construction blocks of the web page in the reconfigured screen, and displaying the relocated web page on the reconfigured screen.

11. The method of claim 10, wherein the step (a) comprises steps of:
determining a screen location mode corresponding to the screen relocation command when the screen relocation command for one of normal mode, narrow mode, and mobile mode is inputted; and
obtaining layout setting values of construction blocks of the web page by analyzing a media query corresponding to the determined screen location mode.

12. The method of claim 10, wherein the step (a) comprises steps of:
checking a screen location mode having a size of a screen nearest to a controlled screen size when the screen relocation command is inputted through a web page interval control function; and
obtaining layout setting values of construction blocks of the web page by analyzing a media query corresponding to the checked screen location mode.

13. The method of claim 10, wherein the step (b) comprises exposing an advertisement in a construction block of the web page in accordance with a predetermined advertisement scheduling algorithm from a time when the layout of the screen starts to be reconfigured until the relocated web page is displayed.

14. An electronic device-readable recording medium on which a method for providing a responsive user interface is recorded as a program, the method comprising steps of:
when a screen relocation command is inputted in a state in which a web page has been displayed, obtaining corresponding layout setting values by analyzing the screen relocation command;
reconfiguring a layout of a screen based on the obtained layout setting values, relocating construction blocks of the web page in the reconfigured screen and displaying the relocated web page on the reconfigured screen.
